(19) United States
(12) Patent Application Publication
(10) Pub. No.: US 2025/0107961 A1
(43) Pub. Date: Apr. 3, 2025

(54) BATHTUB MASSAGE NOZZLE WITH SWITCH FUNCTION AND GOOD MASSAGE EFFECT

(71) Applicant: Guangzhou Rising Dragon Recreation Industrial Co., Ltd., Guangzhou (CN)

(72) Inventors: Huaibin ZHAO, Guangzhou (CN); Xuewen LIU, Guangzhou (CN)

(73) Assignee: Guangzhou Rising Dragon Recreation Industrial Co., Ltd., Guangzhou (CN)

(21) Appl. No.: 18/679,485

(22) Filed: May 31, 2024

(30) Foreign Application Priority Data
Sep. 28, 2023 (CN) 202311270847.7

(51) Int. Cl. A61H 33/02

(52) U.S. Cl. CPC A61H 33/027; A61H 2201/0107

(57) ABSTRACT

A bathtub massage nozzle with switch function and good massage effect is provided. When in use, by aligning a core seat water inlet hole with a water inlet, water enters the nozzle core seat from the water inlet, and at the same time, the air is introduced from an air inlet, so that the air reaches a closed air cavity, and then the water flows out from the other end of the nozzle core seat to reach a gap between the nozzle core seat and the nozzle surface cover; at the same time, the gas is also discharged from an air outlet on the side of the nozzle core seat far away from the core seat water inlet hole through the closed air cavity, which reduces the dilution and loss of bubbles in the process of water flow transmission, and enables the water flow to form dense bubbles.

### TECHNICAL FIELD

The present application relates to the technical field of massage nozzles, in particular to a bathtub massage nozzle with switch function and good massage effect.

### BACKGROUND

In modern society, with the increasing pursuit of quality of life, leisure and relaxation become more and more important. As a way to enjoy comfort and health, bathtub massage has been widely concerned and loved. Bathtub massage can relieve physical fatigue, promote blood circulation and improve psychological comfort, thus achieving the effect of relieving stress and improving health.

However, although the traditional bathtub massage nozzle has certain advantages in providing comfortable bubble massage experience, its design limitations gradually appear. The main problem stems from the relatively close arrangement of the water nozzle and the air inlet in the traditional design, which limits the bubble generation effect and stability to some extent. Specifically, the distance between the water inlet and the air inlet of the nozzle core seat contained in the traditional bathtub massage nozzle is relatively short, resulting in a relatively long gas injection path after the water flows into the nozzle body. This makes the bubbles easily diluted in the process of water flow transmission, and some bubbles may merge or disappear on the way, thus reducing the density and quality of bubbles. Due to the lack of bubble stability, the traditional nozzle may have intermittent bubbles and trickle during use, which affects the consistency and comfort of massage effect. In addition, due to the scarcity and uneven distribution of bubbles, the traditional bathtub massage nozzle may not fully cover the body parts in the bathtub, thus failing to achieve a uniform massage effect. Users may feel that the massage in some parts is weak, and even can't feel the stimulation of bubble massage. This further reduces the overall quality of the massage experience.

Therefore, although the traditional bathtub massage nozzle has certain advantages in generating bubbles and providing massage, its design limitations limit the effect and stability of bubble massage. This is also the problem of continuous improvement in the field of massage nozzles.

### SUMMARY

The present application aims to provide a bathtub massage nozzle with a switch function and a good massage effect, which solves that limitation existing in the traditional design, thereby providing a more excellent and stable bathtub massage experience.

A bathtub massage nozzle with a switch function and a good massage effect, comprises a nozzle body, a nozzle core seat and a nozzle surface cover. The nozzle body comprises a water inlet end and a water spraying end opposite to the water inlet end, the water inlet end is provided with a water inlet and an air inlet; the water inlet and the air inlet are arranged in a staggered manner, and the air inlet is closer to the water spraying end than the water inlet. The water spraying end is formed with an accommodating cavity extending to the water inlet end; the nozzle core seat is arranged in the accommodating cavity, and the nozzle core seat is provided with a core seat water inlet hole. The nozzle core seat is provided with sealing rubber rings between the water inlet and the air inlet and at a side far away from the core seat water inlet hole; the sealing rubber rings are tightly connected with an inner side wall of the nozzle body, and the inner wall of the nozzle body and the nozzle core seat cooperatively form a closed air cavity between the sealing rubber rings. A side of the nozzle core seat far away from the core seat water inlet hole is provided with a predetermined number of air outlet holes; an end of the side of the nozzle core seat far away from the core seat water inlet hole is provided with the nozzle surface cover, and an air outlet end of the air outlet hole is located in a gap between the nozzle core seat and the nozzle surface cover.

Preferably, a portion of the inner wall of the nozzle body adjacent to water spraying end is provided with a first annular groove which is concave toward an outer wall of the nozzle body; an outer side of the nozzle core seat near the nozzle surface cover is provided with a first annular accommodating groove, and the first annular accommodating groove is provided with one of the sealing rubber rings which is adapted to the first annular groove.

It should be noted that the nozzle core seat is inserted through the accommodating cavity contained in the nozzle body, and then the nozzle core seat is pressed, so that the sealing rubber ring arranged on the nozzle core seat is squeezed and compressed. When the sealing rubber ring is pressed to the first annular groove and the second annular groove arranged on the nozzle body, the sealing rubber ring returns to its original shape and correspondingly expands into the first annular groove and the second annular groove, so that the nozzle core seat and the nozzle body can be closely connected and the gap between the nozzle core seat and the nozzle body can be sealed. When the two sides are sealed, a closed air cavity is formed.

Preferably, the middle part of the nozzle surface cover is provided with a support plane, and a cam structure is arranged on the support plane, and a driven member adapted to the cam structure is arranged on the side of the nozzle core seat opposite to the support plane. Further, the cam structure includes a vertical plane perpendicular to the support plane, an arc surface connected to the vertical plane and parallel to the support plane, and an inclined transition surface connecting the support plane to the arc surface.

When the driven member reaches the lowest end where the cam structure is connected with the support plane, the cam structure and the driven member begin to contact. The nozzle core seat is continually rotated, and the driven member will gradually move upward (that is, to the nozzle surface cover side) along the inclined transition surface of the cam structure. Due to the force provided on the side far away from the water inlet end, the sealing rubber ring on the nozzle core seat can be easily separated from the first annular groove and the second annular groove on the nozzle body. The nozzle core seat is continually rotated, and the nozzle core seat can be easily removed from the nozzle body. Through this design, it is simple and convenient to disassemble the nozzle body and nozzle core seat. The user only needs to rotate the nozzle core seat, so that the cam structure can be matched with the driven member, and enough force is provided to make the sealing rubber ring on the nozzle core seat separate from the first annular groove and the second annular groove on the nozzle body. In this way, users can easily replace, clean or repair the nozzle core seat to achieve better maintenance and use experience.

Preferably, a nozzle core is provided at an end of the nozzle core holder away from the water inlet hole of the core holder, and a water outlet is provided on the nozzle surface cover corresponding to the nozzle core.

Preferably, the air outlet hole runs through the nozzle core, and the air outlet end of the air outlet hole is located in the gap between the nozzle core and the nozzle surface cover. The mixing of water and bubbles is allowed to be closer to the side of the water outlet of the nozzle surface cover, and a better massage effect is formed.

When users use it, they can choose different types of nozzle core seats (that is, choose different nozzle cores) according to their own preferences and needs, such as spherical, linear, rotating or porous nozzle cores, so as to obtain personalized and diversified massage effects.

During installation, the connection between the nozzle surface cover and the nozzle core seat is realized by clamping the buckle on the nozzle surface cover into the slot at the nozzle core seat, which is simple and reliable.

Preferably, the outer side of the nozzle body is provided with an external thread. The bathtub massage nozzle with a switch function with a good massage effect further includes a fastener with an internal thread, which is screwed into the external thread of the nozzle body, cooperating with the nozzle surface cover to achieve installation of the bathtub at the installation position.

Compared with the prior art, the present application has the following beneficial effects: the present application provides a bathtub massage nozzle with a switch function with a good massage effect, which includes a nozzle body, a nozzle core seat and a nozzle surface cover, wherein the inner wall of the nozzle body and the nozzle core seat form a closed air cavity in the space between the two sealing rubber rings; when the bathtub massage nozzle is used, by aligning the inlet hole of the nozzle core seat with the water inlet, water enters the nozzle core seat from the water inlet and then flows through the core seat, and at the same time, the air enters via the air inlet, so that air reaches the closed air cavity; then the water flows out from the other end of the nozzle core seat to the gap between the nozzle core seat and the nozzle surface cover, and at the same time, the air also passes through the closed air cavity, and then is discharged from the air outlet hole arranged at the side of the nozzle core seat far from the inlet hole of the core seat. This arrangement can reduce the dilution and loss of bubbles in the process of water flow transmission, and then make the water flow form dense bubbles in the nozzle, which are guided by the nozzle surface cover and released along a specific area of the bathtub. The strength and effect of bubble massage is enhanced, the massage becomes more powerful and exciting, muscle fatigue and stress are better relieved, a richer and denser bubble massage experience is provided, thereby achieving better Venturi effect and venting effect. Therefore, this kind of bathtub massage nozzle with a switch function with a good massage effect has been comprehensively improved in terms of massage effect. By strengthening massage effect, providing full-body meticulous massage and improving stability and durability, it can provide better massage experience and bring better comfort and relaxation effects to users.

### BRIEF DESCRIPTION OF DRAWINGS

FIG. 1 is a schematic structural diagram of a bathtub massage nozzle with a switch function and a good massage effect according to the present application;

FIG. 2 is a schematic cross-sectional structure diagram of the bathtub massage nozzle with a switch function and a good massage effect according to the present application;

FIG. 3 is a partial structural schematic diagram of the bathtub massage nozzle with a switch function and a good massage effect according to the present application;

FIG. 4 is a schematic structural view of the nozzle body according to the present application;

FIG. 5 is a schematic structural diagram of the nozzle core seat according to the present application;

FIG. 6 is a schematic cross-sectional view of a bathtub massage nozzle with a switch function and a good massage effect having a spherical nozzle core;

FIG. 7 is a schematic cross-sectional view of a bathtub massage nozzle with a switch function and a good massage effect having a porous nozzle core;

FIG. 8 is a schematic cross-sectional view of a bathtub massage nozzle with a switch function and a good massage effect having a straight nozzle core;

FIG. 9 is a schematic cross-sectional view of a bathtub massage nozzle with a switch function and a good massage effect having a rotating nozzle core;

wherein:

1—Nozzle body, 2—Nozzle core seat, 3—Nozzle surface cover, 4—Fastener, 5—Closed air cavity, 11—Water inlet, 12—Air inlet, 13—Accommodating cavity, 14—First annular groove, 15—Second annular groove, 16—Cam structure, 17—External thread, 21—Core seat water inlet hole, 22—Air outlet hole, 23—Sealing rubber ring, 24—Second annular accommodating groove, 25—First annular accommodating groove, 27—Driven member, 28—Nozzle core, 29—Slot, 31—Buckle, 32—Water outlet.

### DESCRIPTION OF EMBODIMENTS

The embodiments described below are only part of the embodiments of the present application, but not all of them. Based on the embodiments in the present application, all other embodiments obtained by those skilled in the art without creative work belong to the scope of protection of the present application.

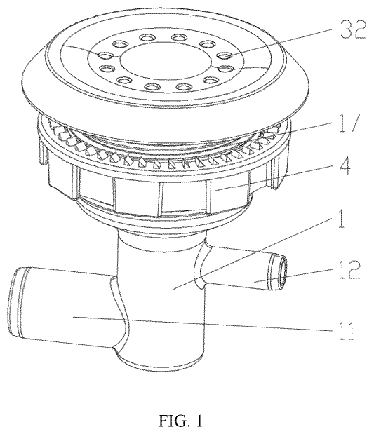

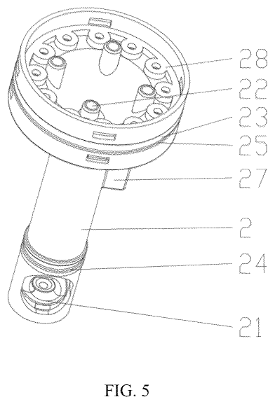

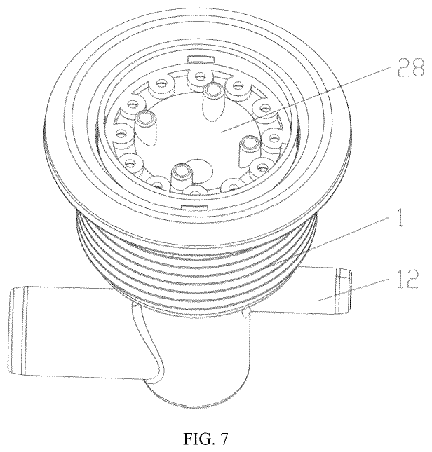

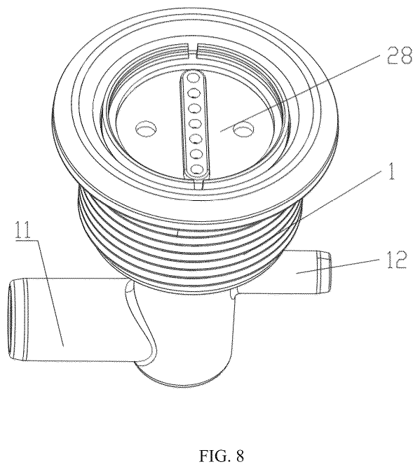

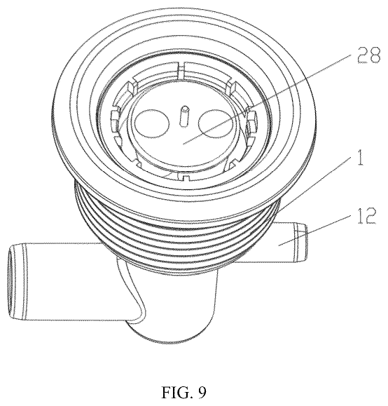

Referring to FIGS. 1-9, this embodiment provides a bathtub massage nozzle with a switch function and a good massage effect, which includes a nozzle body 1, a nozzle core seat 2 and a nozzle surface cover 3. The nozzle body 1 includes a water inlet end and a water spraying end opposite to the water inlet, the water inlet end is provided with a water inlet 11 and an air inlet 12. The water inlet 11 and the air inlet 12 are arranged in staggered manner, and the air inlet 12 is located at a side of the water inlet 11 close to the water spraying end. The water spraying end is formed with an accommodating cavity 13 extending to the side of the water inlet end. The nozzle core seat 2 is arranged in the accommodating cavity 13, and the nozzle core seat 2 is provided with a core seat water inlet hole 21. The nozzle core seat 2 is provided with sealing rubber rings 23 between the water inlet 11 and the air inlet 12 and at a side far away from the core seat water inlet hole 21. The sealing rubber rings 23 are tightly connected with an inner side wall of the nozzle body 1. The inner wall of the nozzle body 1 and the nozzle core seat 2 form a closed air cavity 5 in a space between two sealing rubber rings 23. A side of the nozzle core seat 2 far away from the core seat water inlet hole 21 is provided with a predetermined number of air outlet holes 22 communicating with the closed air cavity 5. An end of the side of the nozzle core seat 2 far away from the core seat water inlet hole 21 is provided with the nozzle surface cover 3, and an air outlet end of the air outlet hole 22 is located in a gap between the nozzle core seat 2 and the nozzle surface cover 3.

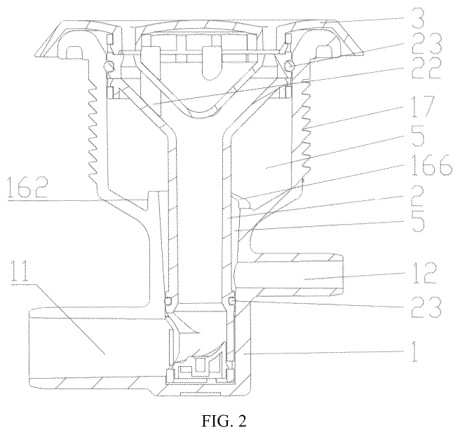

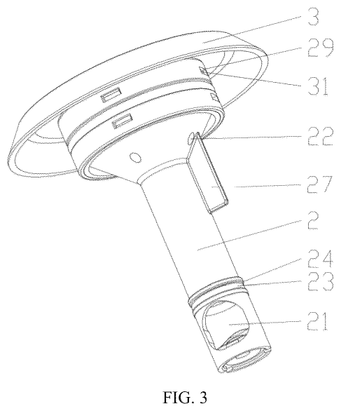

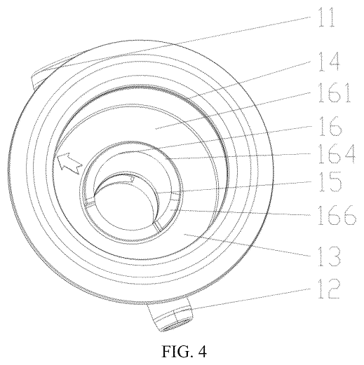

Referring to FIG. 2, FIG. 3 and FIG. 4, it is preferable that the inner wall at the side of the spraying end of the nozzle body 1 is provided with a first annular groove 14 which is concaved toward a side of an outer wall. An outer side of the nozzle core seat 2 near the nozzle surface cover 3 is provided with a first annular accommodating groove 25, and the first annular accommodating groove 25 is provided with the sealing rubber ring 23 which is adapted to the first annular groove 14. Preferably, a second annular groove 15 concaved toward the outer wall is defined in the inner wall of the nozzle body 1 between the water inlet 11 and the air inlet 12, a second annular accommodating groove 24 is arranged on the outer side of the nozzle core seat 2 near the core seat water inlet hole 21, and the second annular accommodating groove 24 is provided with the sealing rubber ring 23 which is adapted to the second annular groove 15.

It should be noted that the nozzle core seat 2 is inserted through the accommodating cavity 13 of the nozzle body 1, and then the nozzle core seat 2 is pressed, so that the sealing rubber ring 23 provided on the nozzle core seat 2 is squeezed and compressed. When the sealing rubber ring 23 is pressed into the first annular groove 14 and the second annular groove 15 provided on the nozzle body 1, the sealing rubber ring 23 returns to its original shape and correspondingly tightens/engages into the first annular groove 14 and the second annular groove 15, so that the nozzle core seat 2 and the nozzle body 1 are closely connected with each other, so that the gap between the nozzle core seat 2 and the nozzle body 1 is sealed. When the two sides are sealed, a closed air cavity 5 is formed.

Referring to FIG. 4, it is preferable that the accommodating cavity 13 of the nozzle body 1 is provided with a support plane 161, and a cam structure 16 is arranged on the support plane 161. A side of the nozzle core seat 2 opposite to the support plane 161 is provided with a driven member 27 corresponding to the cam structure 16. Preferably, the driven member 27 has a plate-shaped configuration. Further, the cam structure 16 includes a vertical plane 162 perpendicular to the support plane 161, an arc surface 164 connected with the vertical plane 162 and parallel to the support plane 161, and an inclined transition surface 166 connecting the support plane 161 to the arc surface 164.

Referring to FIG. 3 and FIG. 4, when the driven member 27 reaches the lowest end where the cam structure 16 is connected with the support plane 161, the cam structure 16 starts to contact with the driven member 27. The nozzle core seat 2 is continually rotated, and the driven member 27 gradually moves upward (that is, toward the nozzle surface cover 3) along the inclined transition surface 166 of the cam structure 16. The sealing rubber rings 23 on the nozzle core seat 2 can be easily released from the first annular groove 14 and the second annular groove 15 on the nozzle body 1 due to the force exerted in a direction far from the water inlet end. The nozzle core seat 2 is continually rotated, and the nozzle core seat 2 can be easily removed from the nozzle body 1. With this design, it is simple and convenient to disassemble the nozzle body 1 and the nozzle core seat 2. The user only needs to rotate the nozzle core seat 2, so that the cam structure 16 can operate with the driven member 27, and enough force is provided to make the sealing rubber rings 23 on the nozzle core seat 2 remove from the first annular groove 14 and the second annular groove 15 on the nozzle body 1. In this way, the user can easily replace, clean or repair the nozzle core seat 2, so as to achieve better maintenance and use experience.

Referring to FIG. 1, it is preferable that the nozzle core seat 2 is provided with a nozzle core 28 at one end far from the inlet hole 21 of the nozzle core seat, and the nozzle surface cover 3 is provided with a water outlet 32 corresponding to the nozzle core 28.

Preferably, the air outlet hole 22 penetrates the nozzle core 28, and the air outlet end of the air outlet hole 22 is located in the gap between the nozzle core 28 and the nozzle surface cover 3, so that the mixing of water and bubbles is closer to the water outlet side of the nozzle surface cover 3, and the air converges with water later, so that compared with the traditional nozzle, the bubble consumption is less, the Venturi effect is better, and a better massage effect can be achieved.

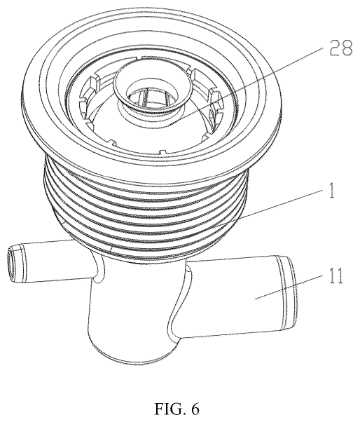

Referring to FIGS. 6, 7, 8 and 9, it is preferable that the nozzle core 28 is a spherical nozzle core 28, a straight/linear nozzle core 28, a rotary nozzle core 28 or a porous nozzle core 28. When users use it, they can choose different types of nozzle core seats 2 (that is, choose different nozzle cores 28) according to their own preferences and needs, such as spherical, linear, rotating or porous nozzle cores 28, so as to obtain personalized and diversified massage effects.

Referring to FIG. 3, it is preferable that the nozzle core seat 2 is provided with a locking slot 29, and the side of the nozzle surface cover 3 is provided with a buckle 31 corresponding to the locking slot 29. During installation, the connection between the nozzle surface cover 3 and the nozzle core seat 2 is realized by engaging the buckle 31 on the nozzle surface cover 3 into the slot 29 at the nozzle core seat 2, which is simple and reliable.

Referring to FIG. 1, it is preferable that the outer side of the nozzle body 1 is provided with an external thread 17. The bathtub massage nozzle with a switch function also includes a fastener 4 with an internal thread. The fastener 4 is screwed on the external thread 17 of the nozzle body 1, cooperating with the nozzle surface cover 3 to realize the installation of the bathtub at the installation position.

It should be noted that when the bathtub massage nozzle with a switch function provided by the present application is used, the nozzle surface cover 3 is rotated to thereby drive the nozzle core seat 2 to rotate, so that the core seat water inlet hole 21 is aligned with the water inlet 11, water enters the nozzle core seat 2 from the water inlet 11 and then enters the nozzle core seat 2 through the core seat; and at the same time, the air enters the closed air cavity 5 through the air inlet 12, and then water flows out from the other end of the nozzle core seat 2 to reach the gap between the nozzle core seat 2 and the nozzle surface cover 3; at the same time, the air is discharged from the air outlet 22 arranged at the side of the nozzle core seat 2 far from the water inlet hole 21 through the closed air cavity 5, and the air discharged from the air outlet 22 reaches the gap between the nozzle core seat 2 and the nozzle surface cover 3 to mix with the internal water, and then the water mixed with bubbles is discharged from the water outlet arranged on the nozzle surface cover 3. The discharged water enhances the strength and effect of bubble massage, making the massage more powerful and exciting, and can better relieve muscle fatigue and stress. When the bathtub is not used, the nozzle surface cover 3 is rotated to further drive the nozzle core seat 2 to rotate, so that the core seat water inlet hole 21 is staggered/offset from the water inlet 11, and the nozzle does not spray water at this time.

The bathtub massage nozzle with a switch function by the present application includes a nozzle body 1, a nozzle core seat 2 and a nozzle surface cover 3, wherein the inner wall of the nozzle body 1 and the nozzle core seat 2 form a closed air cavity 5 in the space between two sealing rubber rings 23; this arrangement reduces the dilution and loss of bubbles in the process of water flow transmission, and further enables the water flow to form dense bubbles in the gap between the nozzle core seat 2 and the nozzle surface cover 3; the bubbles are guided by the nozzle surface cover 3 and released through the water outlet 32 along a specific area of the bathtub. The strength and effect of bubble massage are enhanced, making massage more powerful and exciting, better relieving muscle fatigue and stress, provide richer and denser bubble massage experience, and achieving better Venturi effect and venting effect. Therefore, this kind of bathtub massage nozzle with a switch function with a good massage effect has been comprehensively improved in terms of massage effect. By strengthening the massage effect, providing full-body meticulous massage and improving stability and durability, the bathtub can provide better massage experience and bring better comfort and relaxation effects to users.

The preferred embodiments of the present application disclosed above are only used to help explain the present application, and are not limited to the specific embodiments described. Obviously, according to the contents of this specification, it can be modified and changed. The embodiment selected and specifically described in this specification is to better explain the principle and practical application of the present application, so that the those skilled in the art can better understand and make use of the present application, and it is not a limitation on the present application. Any solution after simple modification of the present application belongs to the protection scope of the present application

What is claimed is:

1. A bathtub massage nozzle with a switch function, comprising a nozzle body, a nozzle core seat and a nozzle surface cover, wherein the nozzle body comprises a water inlet end and a water spraying end opposite to the water inlet end, the water inlet end is provided with a water inlet and an air inlet; the water inlet and the air inlet are arranged in a staggered manner, and the air inlet is closer to the water spraying end than the water inlet;
the water spraying end is formed with an accommodating cavity extending to the water inlet end; the nozzle core seat is arranged in the accommodating cavity, and the nozzle core seat is provided with a core seat water inlet hole;
the nozzle core seat is provided with sealing rubber rings between the water inlet and the air inlet and at a side far away from the core seat water inlet hole; the sealing rubber rings are tightly connected with an inner side wall of the nozzle body, and the inner wall of the nozzle body and the nozzle core seat cooperatively form a closed air cavity between the sealing rubber rings;
a side of the nozzle core seat far away from the core seat water inlet hole is provided with a predetermined number of air outlet holes; an end of the side of the nozzle core seat far away from the core seat water inlet hole is provided with the nozzle surface cover, and an air outlet end of the air outlet hole is located in a gap between the nozzle core seat and the nozzle surface cover.

2. The bathtub massage nozzle with a switch function according to claim 1, wherein a portion of the inner wall of the nozzle body adjacent to water spraying end is provided with a first annular groove which is concave toward an outer wall of the nozzle body; an outer side of the nozzle core seat near the nozzle surface cover is provided with a first annular accommodating groove, and the first annular accommodating groove is provided with one of the sealing rubber rings which is adapted to the first annular groove.

3. The bathtub massage nozzle with a switch function according to claim 2, wherein a second annular groove concave toward the outer wall is defined in the inner wall of the nozzle body between the water inlet and the air inlet, a second annular accommodating groove is arranged on the outer side of the nozzle core seat near the core seat water inlet hole, and the second annular accommodating groove is provided with another of the sealing rubber rings which is adapted to the second annular groove.

4. The bathtub massage nozzle with a switch function according to claim 1, wherein a middle part of the nozzle surface cover is provided with a support plane, and a cam structure is arranged on the support plane; and a side of the nozzle core seat opposite to the support plane is provided with a driven member adapted to the cam structure.

5. The bathtub massage nozzle with a switch function according to claim 4, wherein the cam structure comprises a vertical plane perpendicular to the support plane, an arc surface connected with the vertical plane and parallel to the support plane, and an inclined transition surface connecting the support plane to the arc surface.

6. The bathtub massage nozzle with a switch function according to claim 1, wherein one end of the nozzle core seat far from the core seat water inlet hole is provided with a nozzle core, and the nozzle surface cover is provided with a water outlet corresponding to the nozzle core.

7. The bathtub massage nozzle with a switch function according to claim 6, wherein the air outlet hole passes through the nozzle core, and the air outlet end of the air outlet hole is located in a gap between the nozzle core and the nozzle surface cover.

8. The bathtub massage nozzle with a switch function according to claim 6, wherein the nozzle core is a spherical nozzle core, a straight nozzle core, a rotating nozzle core or a porous nozzle core.

9. The bathtub massage nozzle with a switch function according to claim 1, wherein the nozzle core seat is provided with a locking slot, and a side edge of the nozzle surface cover is provided with a buckle engaging with the locking slot.

10. The bathtub massage nozzle with a switch function according to claim 1, further comprising a fastener with an internal thread, and an external thread is arranged on the outside of the nozzle body; and the fastener cooperates with the nozzle surface cover to clamp the nozzle body for installation and fixation.
